(19) United States
(12) Patent Application Publication
(10) Pub. No.: US 2002/0186434 A1
(43) Pub. Date: Dec. 12, 2002

(54) Transparent photonic switch architectures for optical communication networks

(76) Inventors: Peter David Roorda, Ottawa (CA); Alan Glen Solheim, Stittsville (CA); Greg Peter Friesen, Ottawa (CA); Ryan Erskine Robert Forde, Ottawa (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/140,116

(22) Filed: May 8, 2002

Related U.S. Application Data
(60) Provisional application No. 60/297,233, filed on Jun. 8, 2001.

(51) Int. Cl. H04J 14/02

(52) U.S. Cl. 359/128; 359/127

(57) ABSTRACT

A n×n transparent photonic switch TPS for an optical communication network uses wavelength selective elements connected in the switch fabric, to allow channels to pass, or to block channels from passing according to a network-wide routing connectivity data. The WSE may be a two-port blocker, in which case all input and output ports of the TPS are provided with 1:(n−1) splitters/combiners for providing internal routes between all pairs of input I(i) and output O(j) ports. The WSE may be assembled using wavelength selective switches WSS, or combinations of WSSs, splitters/combiners and circulators.

### PRIORITY PATENT APPLICATION

Provisional U.S. Patent Application “Architecture for a Wavelength Switching Node of a Photonic Network” (Solheim et al) Ser. No. 60/297,233, filed Jun. 8, 2001, docket 1002P.

### RELATED PATENT APPLICATION

U.S. patent application, Ser. No. not received yet, entitled “Architectures for a wavelength switching node of a photonic network” (Solheim et al.) filed Apr. 3, 2002, assigned to Innovance Networks, docket 1002.

U.S. patent application Ser. No. 09/909,265, entitled “Wavelength Routing and Switching Mechanism for a Photonic Transport Network”, Smith et al., filed Jul. 19, 2001, assigned to Innovance Networks, docket 1021.

### FILED OF THE INVENTION

The invention is directed to an optical communication network, and in particular to architectures for a transparent photonic switch TPS for an optical communication network.

### DESCRIPTION OF RELATED ART

Current transport networks are based on a WDM (wavelength division multiplexing) physical layer, using point-to-point (pt-pt) connectivity. Since network flexibility is delivered electronically, termination of the photonic layer is necessary at each intermediate node along a path, and therefore the nodes must be provided with optical-to-electrical-to-optical (OEO) interfaces for each channel. As 65-70% of nodal OEO conversion is for managed passthrough, the cost of the unnecessary OEO conversion of the passthrough traffic represents a very important chunk from the cost of the entire network, having in view that 80% of the network cost is in the nodes.

In addition, OEO conversion requires wavelength-specific equipment at the nodes, resulting in a very complex node structure. For example, an average 2.5 Tb/s 3-way traditional node (add/drop and passthrough node) uses approximately 150 card-pack types, which can be fitted in 20 bays. This large nodal complexity results in increased network management complexity and scalability problems, increased power consumption, and increased system turn-up time. As a consequence, adding new services and providing differentiated services, become increasingly complex and ultimately very costly.

Generally, the photonic nodes can be classified as optical (or wavelength) add/drop nodes, and optical cross-connects. An OADM node comprises an optical add/drop multiplexer OADM connected in the network on a bidirectional line. In other words, an OADM has one input port, which receives a multi-channel (WDM wavelength division multiplexed) signal and an output port, which transmits an output WDM signal. The OADM also has a number of drop ports, that direct the “drop” traffic from the input WDM signal to a local user, and a number of add ports, which direct the user traffic into the output WDM signal. Currently, the multiplexing and demultiplexing operations are performed using cascaded optical filters, at channel or band granularity. Dispersion gratings, and lately small optical switches, or wavelength selective switches are also used for OADMs.

FIGS. 1 and 2 depict some current OADM configurations. Also, the article entitled “The Wavelength Add/Drop Multiplexer for Lightwave Communication Networks” by Giles et al, Bell Labs Technical Journal, January-March 1999, pages 207-229 provides a comprehensive description of the state of the art in this domain.

For larger nodes, i.e. nodes that have more than one input and output line, the passthrough traffic may need also to be switched between the lines. This functionality is currently performed by electrical cross-connects (EXC), which, as indicated above, perform the switching in the electrical domain. Optical cross-connects OXC (also called optical switches) are now coming onto the market. The idea at the base of an n×m optical switch is to redirect a channel from any one of the ‘n’ input WDM signals into any one of the ‘m’ output WDM signals, and also to effect any necessary add/drop (i.e. the OADM is a particular case of the OXC). Fiber gratings, semiconductor amplifiers, liquid crystals, holographic crystals, and micro-electro-mechanical systems (MEMS) are just a few techniques that are considered for building OXCs. For example, Chorum Technology Inc. is making various versions of reconfigurable liquid crystal switches, like 1×2, 2×2 switches; a 4×4 and 8×8 LC based switch was also used for the MONET project.

One of the most common technologies being considered by the telecommunication industry is to redirect light using moveable mirrors known as MEMS. A MEMS array is built of minuscule mirrors (a mirror being no larger in diameter than a human hair) mounted on a surface no larger than a few centimeters square. Each mirror can be moved independently on special pivots to assume two, and lately three positions in the way of a light beam. MEMS have been used successfully for some time for example in modern digital projectors that enable computer-based presentations. Lucent Technologies Inc. proposed recently a 256×256 array for use in a product called LambdaRouter. Another example of a MEMS switch is described in U.S. Pat. No. 6,134,359 (MacDonald) issued on Oct. 17, 2000 and assigned to JDS Fitel Inc.

However, it is not easy to implement complex nodes that provide photonic switching and add/drop based on these techniques. Thus, it is difficult to manufacture reliable switches with high port counts. 3D MEMs products in particular seem to have an issue with the volume of control code for mirror positioning. While the advantages of avoiding OEO conversion are significant, these solutions still result in high costs.

Scalability of the switch and of the node is also a problem. In most cases, it is not possible to scale-up the node without replacing the switch, the demultiplexer (that separates all input WDM signals into components prior to switching) and the output multiplexer (which combines the channels into the output signals after switching).

Still further, the current configurations are not flexible, since the ports of the input demultiplexer, switch and output multiplexer are wavelength-specific.

Yet another problem of these switches is blocking. Thus, if two input signals are carried on the same channel (same wavelength, arriving on different input ports) an attempt to route these signals onto the same output fiber will result in loss of information on both signals. As the number of ports increases, the chance of blocking also increases. Switches can be designed to avoid blocking by using for example wavelength converters at both the input or/and output; however, this results in cost increases. Blocking can also be addressed by using excess transmission capacity, again with the result of increased cost.

The advantages of avoiding the OEO conversion are significant. Optical switching is cheaper, as there is no need for expensive high-speed electronics at each node. Removing this complexity results is physically smaller nodes. Additionally, optical switches can operate at much higher speeds than the EXCs. Still further, the design of the optical switches is relatively bit-rate independent so that future upgrades of bit-rate can be performed without upgrading the switch.

International application WPO 00/05832 (Huber et al.) published on Feb. 3, 2000 and assigned to Corvis Corporation, describes a communication system that uses an n×m optical switch. The switch fabric comprises optical guides between any input and output port and a waveband selector on each optical guide to prevent a certain wavelength band from passing to the output. In one embodiment, the waveband selectors are doped optical fibers, which absorb all channels in a certain band. When these channels are to be passed to the output, the doped fiber is supplied with energy from a pump to overcome the absorption of the doped fiber. Other embodiments of the wavelength selector proposed in this document are Bragg gratings, which could be fixed or transiently produced gratings.

However, as this switch operates on bands of channels, it does not allow differentiated services at the channel granularity. Also, this switch is expensive, in that the wavelength switching elements WSE it uses require rather large optical amplifiers (for an entire band of channels), and also require a different type of filter on each internal route. Another drawback is scalability and the inefficient use of bandwidth (it requires gaps between bands).

There is a need to provide the switching nodes of an agile optical network with optical switches of large capacity, which are easy to scale, and allow automatic, flexible switching of channels from input to output ports in a wavelength selectable manner, with minimal blocking.

### SUMMARY OF THE INVENTION

It is an object of the invention to provide architectures for a transparent photonic switch for use in optical communication networks.

Accordingly, the invention provides a method of routing a communication channel at a transparent photonic switch TPS, comprising: broadcasting an input multi-channel optical signal along a plurality of internal routes, an internal route for connecting an input port of the TPS to an output port of the TPS; on each the internal route, selecting a set of channels destined to a respective output port, while blocking all remaining channels destined to other output ports; and dynamically allocating the channels in the set of channels according to current network-wide connectivity data.

According to another aspect, a transparent photonic switch TPS with n input ports and n output ports is provided in an optical communication network, the TPS comprising: an internal route for each I(i)-O(j) pair of ports, where i j a wavelength selective element WSE on each internal route for allowing a set of channels to pass from the input port I(i) to the output port O(j), and blocking all channels destined to other output ports O(k), where k j; and a controller for dynamically allocating the channels in the set of channels according to current network-wide connectivity data.

Still further, the invention is concerned with an optical communication network equipped with a transparent photonic switch TPS with n input ports and n output ports, comprising: for each pair of ports I(i)-O(i), means for routing an eastbound WDM signal and an westbound WDM signal between the input port I(i), output port O(i) and a TPS port P(i); an internal route for each P(i)-P(j) pair of ports; a wavelength selective element WSE on each internal route for allowing a set of channels to pass from the port P(i) to the port P(j), and blocking all channels destined to other ports P(p), where p j, and a controller for dynamically allocating the channels in the set of channels.

According to another aspect, the invention provides a transparent photonic switch TPS for an optical communication network comprising: n bidirectional TPS ports P(i) for connecting the TPS with a respective associated input port I(i) and output port O(i); on each the port P(i), a wavelength selective element WSE with an express port connected to the port P(i), and (n−1) add/drop ports, for routing a set of channels between the express port and a respective add/drop port; a plurality of internal routes for connecting each the add/drop port of each WSE(i) with an add/drop port of each other WSE(j), where i j and a controller for dynamically allocating the channels in each the set of channels according to current network-wide connectivity data.

According to a further aspect, the invention provides a transparent photonic switch TPS for an optical communication network comprising: n input ports I(i) and n output ports O(i); on each input port I(i), an input wavelength selective element WSE with an express port connected to the input port I(i), and with (n−1) drop ports, for routing the set of channels between the express port and a respective drop port; on each output port O(i), an output device with an express port connected to the output port O(i), and with (n−1) add ports, for routing the set of channels between a respective add port and the express port; a plurality of internal routes for connecting each the drop port of each the input WSE(i) with an add port of each other output WSE(j), where i j; and a controller for dynamically allocating the channels in each the set of channels C(k) according to current network-wide connectivity data.

Still further, the invention is concerned with an optical add/drop multiplexer OADM with a first and a second line port connected into a bidirectional line of an optical communication network, comprising: a first 1×n wavelength selective switch WSS with a first input/output port, a first through port and a plurality (n−1) of first add/drop ports, for routing a set of passthrough channels between the first line port and the first through port; a second 1×m WSS with a second input/output port, a second through port and a plurality (m−1) of second add/drop ports for routing the set of passthrough channels between the second line port and the second through port; a passthrough route for routing the passthrough channels between the first and second line ports; and a controller for dynamically allocating the channels in the set of passthrough channels according to current network-wide connectivity data.

The node configurations of the present invention are generically defined as transparent photonic switches; this term includes OXC, OADM and hybrid architectures.

Advantageously, the transparent photonic switch (TPS) according to the invention supports switching individual wavelengths (channels) from an input port to any fiber output, or to any local drop port for termination. This operation is accomplished entirely in the photonic domain, thereby eliminating most of the costs accrued by a passthrough wavelength required with today's technology. The TPS according to the invention also enables a simpler network engineering and planning, which results in significantly reduced time-to-service.

The TPS according to the invention does not require redundant switch planes. A failure in the switch affects only one transmission line; the network is able to automatically reroute the traffic on an alternate path.

Still another advantage of the TPS according to the invention is the scalability of the design, which is based on a modular configuration. The configuration may be expanded from a low to a high density of traffic channels by simply adding further modules to the current structure. This allows a network provider to upgrade a switching node in increments from an initial low-cost configuration to larger configurations, according to the demand for new services. It also results in cost savings, as a network provider is no longer required to buy extra capacity for future services at the time of network deployment.

### BRIEF DESCRIPTION OF THE DRAWINGS

The invention has other advantages and features which will be more readily apparent from the following detailed description of the invention and the appended claims, when taken in conjunction with the accompanying drawing, in which:

FIGS. 1A to 1C (Prior art) show configurations of optical add/drop nodes using a multi-port optical de/multiplexer with fixed port allocation;

FIGS. 2A-2C (Prior art) illustrate configurations using cascaded low port count add/drop devices;

FIG. 3A shows a blocker-based unidirectional TPS according to one embodiment of the invention;

FIG. 3B illustrates a variant of the embodiment of FIG. 3A;

FIG. 4 illustrates an embodiment of a bidirectional, blocker based TPS according to the invention;

FIG. 5A shows a wavelength selective element WSE for a port of a TPS, using a high port-count wavelength selective switch (WSS);

FIG. 5B shows a variant of a WSE of FIG. 5A, using lower port-count WSSs;

FIG. 5C shows another embodiment of a WSE, using cascaded WSSs;

FIG. 6A illustrates an embodiment of a 1×4 WSS based, bidirectional TPS;

FIG. 6B shows the unidirectional variant of the TPS of FIG. 6A;

FIG. 7A shows another embodiment of a bidirectional, 1×2 WSS-based TPS using splitter-combiners;

FIG. 7B illustrates the configuration of a bidirectional port of a 1×N WSS based TPS that may be used in the embodiment of FIG. 7A for larger TPSs;

FIG. 7C illustrates the configuration of a port of a 1×N WSS based TPS that may be used in the embodiment of FIG. 7A for larger TPSs;

FIG. 8A illustrates still another embodiment of a 1×2 WSS based bidirectional TPS using splitters/combiners;

FIG. 8B is the unidirectional version for the configuration of FIG. 8A;

FIG. 9A shows a flexible optical add/drop module using low port-count WSSs;

FIG. 9B shows a flexible optical add/drop module using high port-count WSSs;

FIG. 10A is a variant of the add/drop module of FIG. 9B where the first WSS is bypassed on the through port;

FIG. 10B is another variant of the add/drop module of FIG. 9B where the second WSS is bypassed on the through port at combiner; and

FIG. 10C shows a configuration of a flexible add/drop module using multiports WSSs with a subtending splitter/combiner.

### DESCRIPTION OF THE PREFERRED EMBODIMENTS

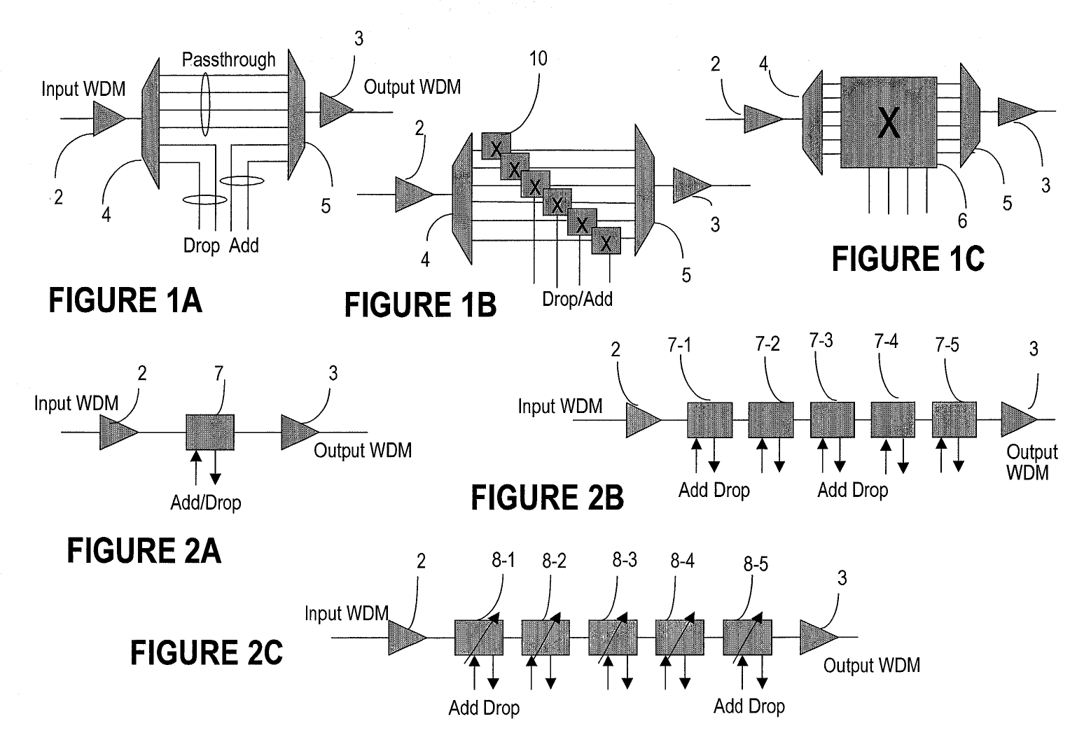

FIGS. 1A -1C show configurations of optical add/drop nodes using optical multiplexers/demultiplexers for describing some principles, devices and terms used for the transparent photonic switches and the optical add/drop multiplexer configurations of the invention.

In the configuration of FIG. 1A, the WDM input signal is pre-amplified by an optical amplifier 2 and then demultiplexed by a demultiplexer 4. Demultiplexer 4 is in general made of cascaded filters, which separate the input WDM signal into component channels or bands of consecutive channels, according to their wavelength. The drop channels at the output of the demultiplexer 4 are routed to the node access structure (not shown) and the passthrough channels are directed to a multiplexer 5. Multiplexer 5 collects the passthrough channels and merges these with the local add channels, to provide the output WDM signal. The postamplifier 3 amplifies the output WDM signal to compensate for the losses in the OADM.

A major drawback of the architecture of FIG. 1A is the fixed port allocation at devices 4 and 5, which is due to use of fixed wavelength filters. Thus, the demultiplexer 4 and multiplexer 5 must be replaced if the wavelengths in the input and output WDM signal are changed. In other words, this configuration does not support tunability. In addition, the connections between the output ports of the demultiplexer and the input ports of the multiplexer are fixed (permanent), as well as the connections between the add/drop ports and the access structure. If the allocation of passthrough versus drop/add channels changes, devices 4 and 5 must be reconnected.

Furthermore, if the density of channels in the WDM signal increases, both devices 4 and 5 need to be replaced with devices with larger port counts. As a result, this configuration is expensive, and requires traffic interruption for upgrades, changes of wavelengths, or changes in channel/port allocation.

Still further, this configuration is expensive in networks with high channel density, and which operate at wavelength granularity, being more suitable for band granularity (i.e. if the ports provide a band of successive channels). However, band multiplexers/demultiplexers require guard bands, which result in stranding of capacity. It is also possible to use a hybrid band/wavelength configuration, with the respective compromise.

FIG. 1B shows a similar configuration, where a better flexibility is obtained by using optical switches 10 on all channels. Demultiplexer 4 separates the channels in the WDM signal and the switches 10 direct each channel to an input port of multiplexer 5, or to a drop port. Some or all of the switches 10 also route the add channels to an input port of the multiplexer 5. This configuration has similar drawbacks to those of FIG. 1A, except for a better flexibility.

FIG. 1C shows a configuration where the switches 10 are replaced with a large port-count optical switching array 6 to provide a node with full 3-way connectivity. However, this configuration has a high initial cost and it does not scale well. Thus, the user must install a larger configuration (i.e. devices 4, 5 and 6 with a higher number of ports than needed initially) to allow for further growth.

FIGS. 2A-2C illustrate configurations using cascaded low port-count add/drop devices 7. Devices 7 in FIGS. 2A and 2B could be, for example, dielectric or fiber Bragg grating add/drop filters, which enable fixed (wavelength specific) add/drop. These could be band filters, or wavelength filters.

A single band/wavelength can be added/dropped with the embodiment of FIG. 2A. For larger add/drop needs, FIG. 2B shows a configuration with a plurality of filters 7-1 to 7-5 cascaded in the line. Each filter 7 adds/drops a different band/wavelength. To allow flexible add/drop, fixed filters 7 of FIGS. 2A and 2B may be replaced with tunable filters, as shown by devices 8-1 to 8-5 in FIG. 2C. Nonetheless, since each filter introduces a loss, the cascaded configurations of FIGS. 2B and 2C may be used for low add/drop only. In addition, scalability beyond a small number of add/drop ports is difficult without service disruption.

As indicated in the “background of the invention” section, cross-connecting the lines in optical network is currently performed using EXC (electrical cross-connects). Some optical solution are also considered now, with the disadvantages listed above.

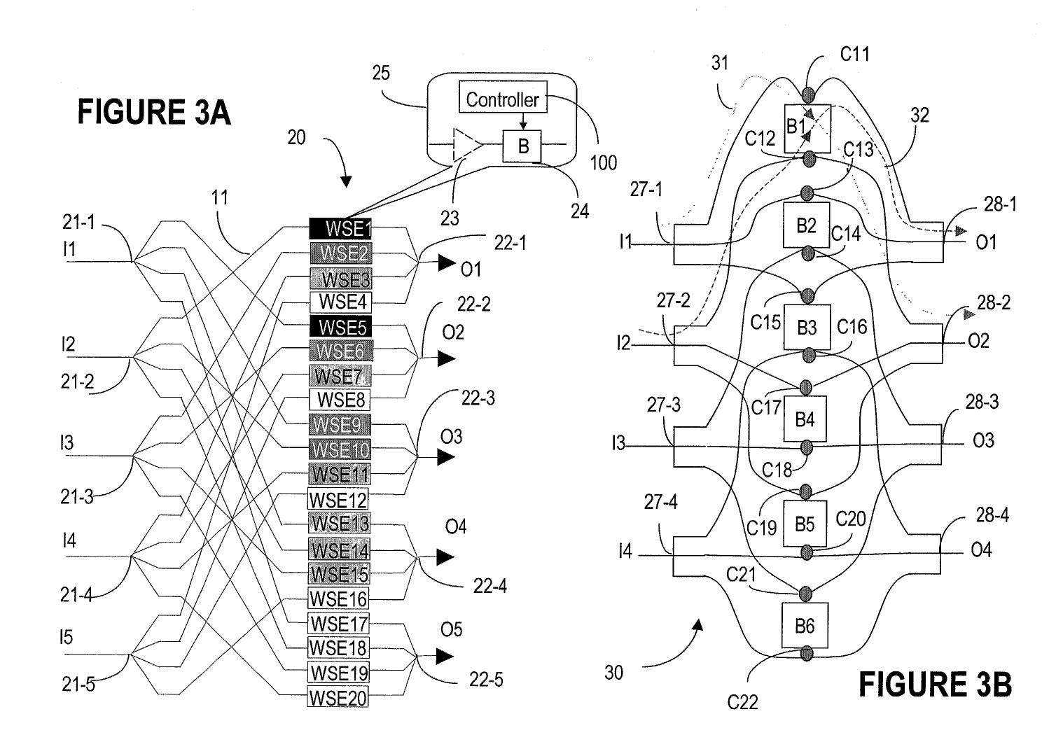

FIG. 3A shows an embodiment of a TPS according to the invention, namely a unidirectional five-port TPS 20, as described and shown in FIGS. 2A-2D of the priority patent application Ser. No. 60/297,233, docket 1002, identified above.

The terms “input port I(i)” and “output port O(j)” are used for the ports that connect the TPS to the optical network (i.e. the line system). The term “internal route” is used for a route within the TPS, which connects an input and an output port of the TPS, as shown for example at 11.

On the input side, a 1×5 TPS 20 comprises on each input port I(i) a 4-way splitter 21-i for broadcasting the input WDM signal to all other output ports O(j), where i j along an associated internal route 11. On the egress side, the TPS 20 comprises on each output port a 4-way combiner 22-i, for combining the signal on four internal routes wavelength into a respective output WDM signal O(j).

A wavelength selective element WSE 25 is connected along each internal route, to selectively and controllably allow a set of wavelengths to pass, and to block all other wavelengths. The set of channels (or wavelengths) that are allowed to pass through the blocker 24 may include one or more channels; the channels need not be consecutive. The wavelengths in the output WDM signal on each line depend on the setting of the respective WSE 25. For example, the channels in the WDM signal on port O1 depends on the setting of WSE1 to WSE4.

A wavelength selective element 25 comprises in this embodiment a blocker 24, which has a wavelength-dependent transfer characteristic, and a controller 100 that adjusts the transfer characteristic of the blocker. The blockers 24 are bidirectional devices, which block/allow a set of channels in each direction. For example, the blockers may be devices of manufacture by JDS Uniphase. A WSE 25 may also comprise an EDFA 23 for compensating for the losses in splitter 21, blocker 24 and combiner 22.

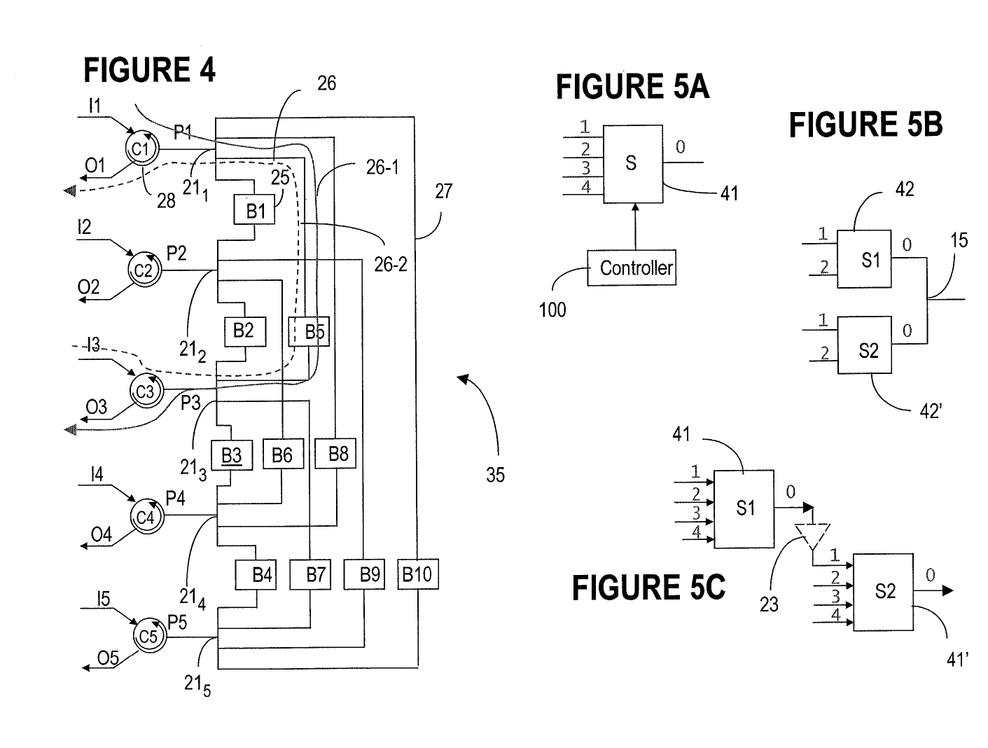

Controller 100 dynamically adjusts the blocker 24 to select/block the channels passing through that internal route as needed, based on network-wide connectivity data received from a routing and switching R&S controller (not shown). Details on operation of controller 100 are provided in the copending U.S. patent application Ser. No. 09/909,265, docket 1021, fully identified above, which is incorporated herein by reference. To summarize, in response to a connection request, the R&S controller finds an end-to-end route across the network, places regenerators at some intermediate nodes along the route if/when necessary, and routes the signal in optical format through other intermediate nodes. In this way, the optical channel carrying the client signal may be sourced at a switching or OADM node (at the source transmitter or intermediate regenerating nodes), may be passed through a node in optical format, or may be terminated at a node (at the destination receiver or at intermediate regenerating nodes). The selection of a wavelength for a channel along an optical path is based on wavelength availability, network topology data and wavelength performance data. The embedded controller 100 is shown in more details in FIG. 4 of the priority patent application Ser. No. 60/297,233, docket 1002P, and in FIG. 3A of the co-pending U.S. patent application identified above, docket 1002; its operation is described in the accompanying text.

For example, if a route carries the traffic for a certain end-to-end connection on a channel λ1, and the route requires cross-connecting input line I2 to output line O1, controller 100 sets the transfer characteristic of blocker B1 so as to allow λ1 to pass, and sets blockers WSE2, WSE3 and WSE4 to block λ1.

It is to be noted that controller 100 is not illustrated on the reminder of the figures for simplification. It is also to be noted that for simplification, the WSEs that use blockers are identified simply as blockers.

The TPS of FIG. 3A may be generalized for n input/output ports. For a n×n TPS 20, each input port I(i) is connected to (n−1) output ports O(j) where i j, using n (n−1)-way splitters 21 and n (n−1)-way combiners 22. As a result, the switch has a total of n(n−1) internal routes, and uses n(n−1) WSEs 25.

The architecture of FIG. 3A is scalable and allows equipping the switch in stages, commencing with a small initial investment. Thus, the initial configuration can be built with two 1:s splitters, two s:1 combiners and two wavelength selective elements WSE1 and WSE5, shown in black, to cross-connect two lines I1-O1 and I2-O2. As a new line I3-O3 is installed at the node, the line is equipped with the respective splitter 21-3 and combiner 22-3 and four more wavelength selective elements WSE2, WSE6, WSE9 and WSE10 connected on the internal routes cross-connecting the new line with the first two lines, as shown in dark gray. The WSEs shown in light gray are connected when an additional line I4-O4 is installed, with the respective splitter 21-4 and combiner 22-4. Finally, the WSEs shown in white are connected when the fifth line I5-O5 is installed.

The configuration of TPS 20 is suitable for medium port count switch structures. FIGS. 3B shows an architecture that achieves cost effective higher port count switch structures, by reducing the number of WSEs. It illustrates a unidirectional TPS 30 that cross-connects four lines (n=4), using input 1:3 splitters 27-1 to 27-4, output 3:1 combiners 28-1 to 28-4 and blockers B1 to B6 connected between input and output lines as shown.

In this configuration the blockers are used bidirectionally. For example, blocker B1 allows channel λj to pass from input I1 to output O2, as shown by dotted line 31, and also allows channel λj to pass from I2 to O1, as shown by dashed line 32. Nonetheless, the internal routes are still unidirectional, as blocker bidirectionality is obtained by providing each blocker with two circulators C11 to C22.

TPS 30 of FIG. 3B could be used when minimization of optical degradations due to connection reflections is a design requirement. In addition, because the internal routes are unidirectional, it allows insertion of optical amplifiers (not shown), which operate typically unidirectionally for compensating the losses inside the switch.

FIG. 4 shows an example of a bidirectional, blocker-based transparent photonic switch 35. The switch in this embodiment has n=5, i.e. five input/output ports P1-P5 with a split/combine ratio of 4 ((n−1)=4 in this example). Circulators C1-C5 are provided on each port to make the ports bidirectional. As in the above example, the input ports are denoted with I(i), output ports with O(i) and the TPS ports with P(i).

For switching a channel λj from input line I1 to output line O3, as shown by route 26-1, the WDM signal entering on port P1 is separated into four components by the respective 1:4 splitter/combiner 21₁. Each output port of splitter 21₁ is connected to an input port of a 4:1 combiner/splitter 21₂ to 21₅ through a wavelength selective element 25, denoted with B1, B5, B8 and respectively B10 according to the blocker 24 in the respective WSE. Blockers B1, B8 and B10 block channel λj in the above example (and possible other channels), from passing to the respective output line, while allowing other channels to pass. On the other hand, blocker B5 is set to allow λj to pass to port P3. This channel is combined at port P3 in combiner 21₃ with other channels intended for line O3, after which circulator C3 directs the resulting output WDM signal on the line O3.

In this configuration, the blockers are used bidirectionally, and since the splitter/combiners 21₁ and 21₃ are inherently bidirectional, the same channels are blocked/allowed to pass in the counter-propagating signals traveling on an internal route. For example, signals 26-1 and 26-2 which comprise a specific set of channels, travel in opposite directions through blocker B5 along internal route 26; channel λj is allowed in both signals 26-1 and 26-2, and blocked by e.g. blocker B10 on the internal route 27 in both directions. In this way, the number of blockers is reduced in half when compared with the unidirectional configuration of FIG. 3A.

TPS 30 may be scaled-up by adding WSEs. Thus, for the general case of an n×n TPS, the splitters/combiners 21 have a ratio of (n−1) and the number of WSEs grows with (n−1) for each additional port.

FIGS. 5A-5C show various wavelength selective elements WSEs based on wavelength selective switches WSSs. Thus, FIG. 5A shows a 1×4 WSS 41 (1×(n−1) in the general case) that may be controlled to switch the channels in the input WDM signal four ways. Such control may be again performed using an embedded controller 100, which adjusts the transfer characteristic (function) of the WSSs, according to network-wide connectivity data. Controller 100 is shown only on FIG. 5A, for simplifying the drawings illustrating the remainder of WSS-based TPS architectures.

Port “0” of switch S1 is referred to as the “input/output” port, and ports “1” to “4” are referred to as the add/drop ports. The channels on port “0” can be dynamically allocated to any of the add/drop ports.

FIG. 5B shows a WSE configuration built with two lower port count WSSs, namely with two 2-port WSSs 42 and 42′ and a splitter/combiner 15. For the general case, two n×1 WSSs can make a (2n)×1 TPS. Switches S1 and S2 need to accept three states for each wavelength, namely a pass from port “0” to port “1”, a pass from port “0” to port “2” and a block state. This is to avoid channel collision as the combiners 15 merge the signals on the input/output ports of the respective WSSs. In this case, the term “express port” of the WSE refers to the common port of combiner 15, and the term “add/drop ports” of the WSE refers to ports “1” and “2” of WSS S1 and ports “1” and “2” of WSS S2.

FIG. 5C shows a WSE comprised of two cascaded n×1 WSSs 41 and 41′. This combination can provide a (2n−1)×1 TPS. An amplifier 23 may be used in this configuration between the switches S1 and S2, as shown. In this case, the term “express port” of the WSE refers to input/output port “0” of S2, and the term “add/drop ports” of the WSE refers to ports “1” to “4” of WSS S1 and ports “2” to “4” of WSS S2.

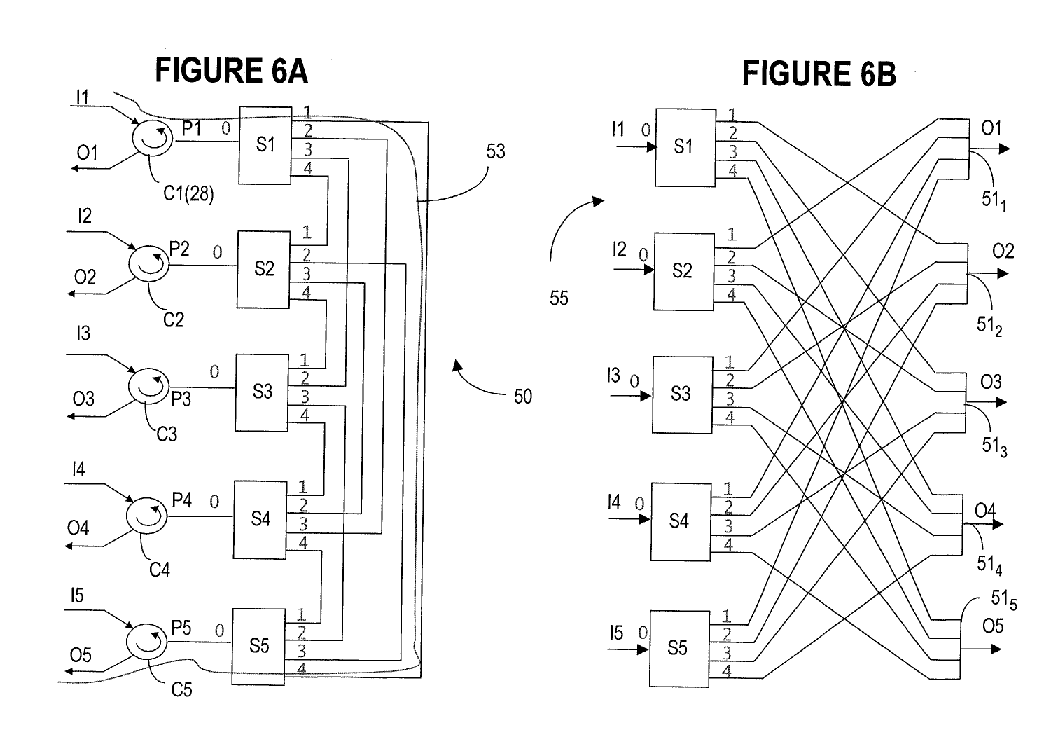

FIGS. 6A and 6B illustrate embodiments of transparent photonic switches using WSEs as shown in FIG. 5A. Thus, the TPS 50 of FIG. 6A uses five 1×4 WSSs 41, denoted with S1, S2, S3, S4 and S5, respectively. TPS 50 is a version of the embodiment 30-1 shown in FIG. 3A of the priority provisional application Ser. No. 60/297,233, docket 1002.

Since switches 41 are bidirectional, bidirectional operation of TPS 50 may be obtained by providing each input-output port pair I1-O1, I2-O2, I3-O3, I4-O4, and I5-O5 with a circulator 28, denoted with C1-C5. Each WSSs 41, such as S1 is connected with port “0” to the associated circulator C1. The drop ports “1” to “4” of S1 are each connected to an add port “4” to “1” of the remaining WSSs S2, S3, S4 and S5. An example of such a connection is shown for route 53 between input port P1 and output port P5. As the ports are bidirectional, a similar arrangement is used for the other direction, i.e. the add ports“1” to “4” are connected to a drop port of the remaining switches S2, S3, S4 and S5.

For the general case, an n×n TPS 50 uses ‘n’ WSSs 41 with (n−1) add/drop ports. A channel, such as channel λj on connection 53 in the above example, passes through two WSSs S1 and S5 between input line I1 and output line O5, experiencing a constant loss of 2·L_{a/d}, where L_{a/d} is the add/drop loss.

FIG. 6B shows a unidirectional TPS 55, that uses 1×4 WSSs 41, namely S1 to S5, on the respective input ports I1 to I5, and combiners 51₁ to 51₅ on the output ports O1 to O5.

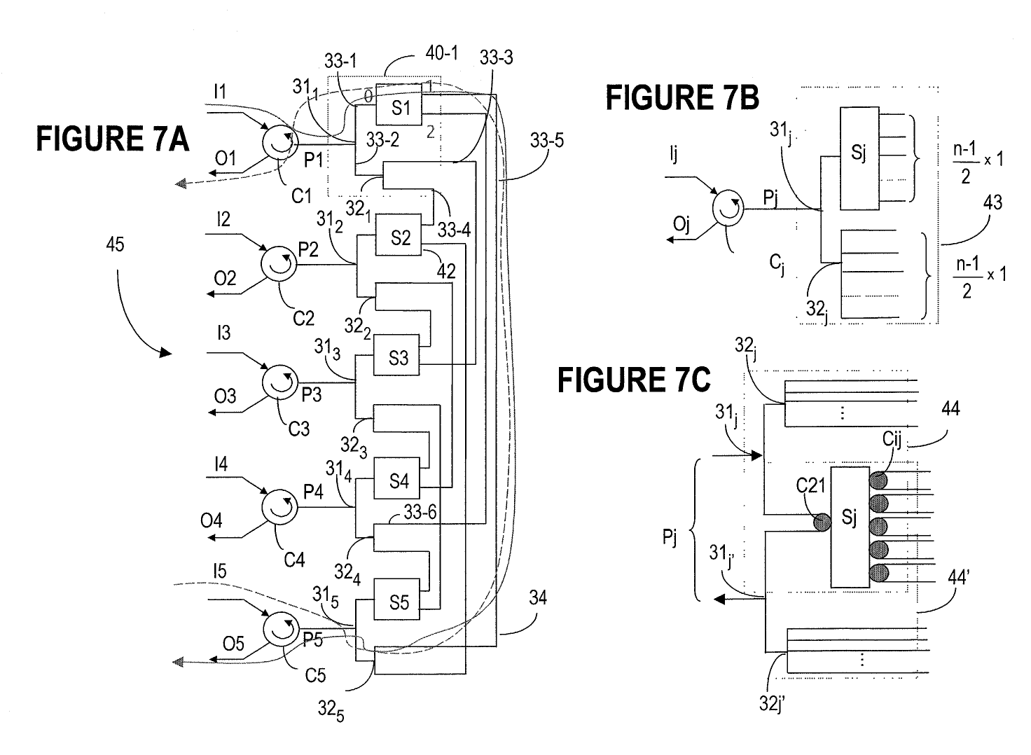

FIG. 7A shows a five-port bidirectional transparent photonic switch 45 built with five wavelength selective elements WSEs 40. This configuration is shown in FIG. 3D (switch 304) of the priority patent application Ser. No. 60/297,233, docket 1002.

As in the examples of FIGS. 4 and 6A, the input I1-I5 and output O1-O5 lines are separated using circulators C1-C5, to make the switch bidirectional. Each WSE 40 comprises in this embodiment a first 1:2 first splitter/combiner 31, a 1×2 WSS 42 and a second 1:2 splitter/combiner 32. In this embodiment, the term “express port” of the WSE refers, for example for port P1, to the common port of combiner 31, and the term “add/drop ports” of the WSE refers to ports “1” and “2” of WSS S1 and the arms of splitter combiner 32.

On the input side of the switch, using the example of the WDM input signal I1, first splitter 31₁ separates the WDM signal on port P1 into two components and routes these components along internal routes 33-1 and 33-2. The second splitter 32₁ separates route 33-2 into two routes 33-3 and 33-4.

On the output side of the TPS 45, the components on route 33-2, which include all channels in the input WDM signal I1, are directed to S2 and respectively S3, from all channels destined to output port O2 (over P2) are routed to combiner 31₂, and the channels destined to output port O3 (over port P3) are routed to combiner 31₃. These combiners merge the respective channels with other channels arriving on the routes merged by the respective combiner 32₂ and 32₃ to form the respective output signals O2, O3.

S1 selectively switches the channels in the component received on route 33-1 (which again include all channels in the input WDM signal I1) over one of internal routes 33-5 and 33-6. The channels are thereafter merged with other channels by cascaded combiners 32₅ and 32₄, into a respective output signal O5, O4.

In the above example, S1 routes a selected channel 34 (λj) along an internal route 34 to 32₅. Since the WSS and the optical combiner/splitters are bidirectional, the reverse path on the same wavelength forms a bidirectional oute 34 through the switch.

WSSs S1-S5 of TPS 45 must have a block state for each wavelength, so as to avoid presence of a channel on both internal routes at a combiner. For example, a same channel cannot be routed along both internal routes 33-3 and 33-4. In other words, a WSS of TPS 40 has three states for each wavelength. It switches a channel λj from input port “0” to drop port “1”, to drop port “2” or blocks it.

Optical amplifiers may be provided on internal routes 33-1 and 33-2 to compensate for the losses in the switch and combiners/splitters. They must be bidirectional, or pre-post amplifiers with circulators.

The loss along a connection such as 34 is L_{a/d}+3·Lₛₚₗᵢₜ, as a channel traveling on this passes through, in this order, splitter 31₁, WSS S1 (port “0” to port “1”), combiner 32₅ and combiner 31₅. L_{a/d} is the loss introduced by a switch switch, and Lₛₚₗᵢₜ is the loss in a splitter/combiner.

An advantage of this version is halving the number of WSS switches when compared to a unidirectional version of the switch.

TPS 45 can be cost-effectively scaled using WSSs with a higher number of add/drop ports and the associated WSSs. This architecture can be generalized to a ‘n’ port device, where ‘n’ is an odd integer. Each port j may be configured with WSEs 43 as shown in FIG. 7B. In this case, the WSE 43 uses (n−1)/2×1 switches Sⱼ, a 2:1 splitter/combiner 31, and a (n−1)/2:1 splitter/combiner 32.

FIG. 7C shows a further variant of an embodiment of a WSE that may be used on the ports of the TPS 45. In this embodiment, each input side of port Pj is equipped with a 1:2 splitter 31j, which routes the input signal to a 1:n splitter 32j, and to a switch Sj. Similarly, each output side of port Pj is equipped with a 2:1 combiner 31j′, which joins the output of an n:1 combiner 32j′ and of the switch Sj into the output signal. Switch Sj is provided with a circulator C21 on the express port and circulators Cij on all add/drop ports, to constrain the bidirectional operation of the TPS 45 to the WSSs. In other words, the internal routes are unidirectional, while the WSSs are operated bidirectionally. This configuration allows unidirectional amplification to be provided on the internal routes as required.

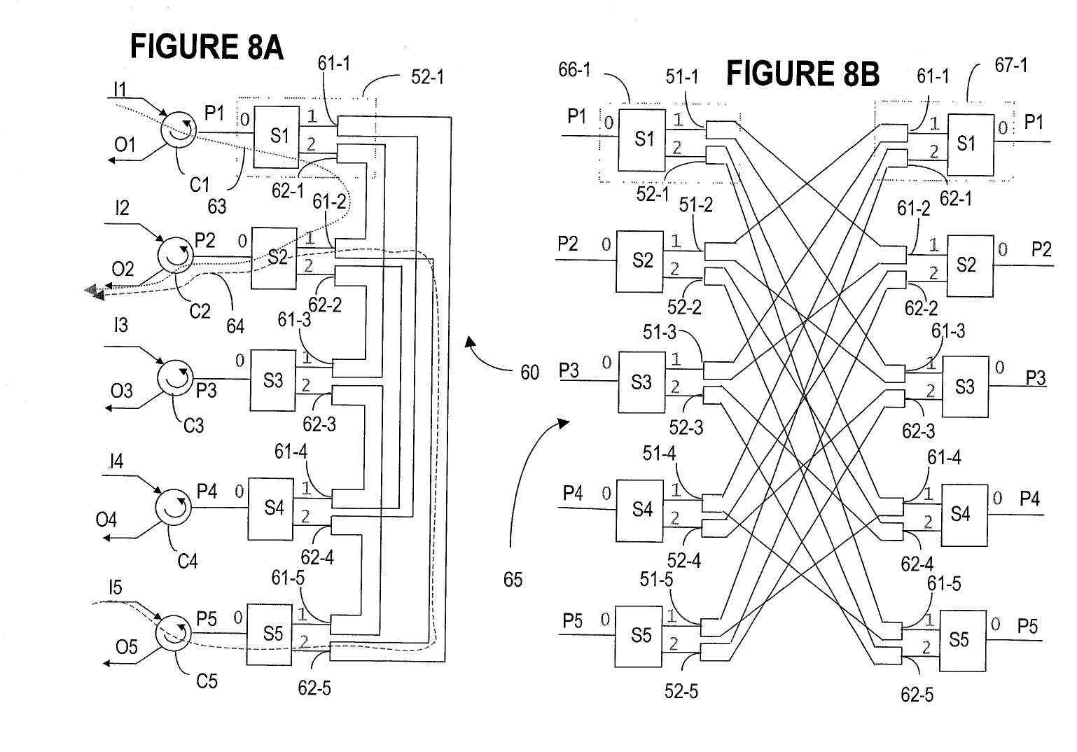

FIG. 8A shows an embodiment of a 5×5 TPS 60 that uses five WSEs 52 (one on each port), as shown for P1 at 52-1. This configuration is similar to configuration 30-2 shown in FIG. 3B of the priority patent application Ser. No. 60/297,233, docket 1002. Circulators C1 to C5 are provided on each input-output pair of ports, to make switch 60 bidirectional. Each WSE 52 comprises in this embodiment a 1×2 WSS 42 connected with the express port to a respective input/output port. The add/drop ports of each WSS 42 are separated on two internal routes using 1:2 splitters/combiners 61 and 62, to increase the capacity between the switch blocks. A device 61, 62 is connected with the common port to a respective add/drop port, and with the arms to a respective internal route. In this embodiment, the term “express port” of the WSE refers to port “0” of WSS S1, and the term “add/drop ports” of the WSE refers to the arms of splitter/combiners 61, 62.

In this embodiment, m=2 (a WSS has two add/drop ports), and the split ratio is 2 (splitters/combiners 61 and 62 are 1:2 devices). Since n=5 (five input/output lines), the number of blocked routes is 1 out of 3 other routes, as shown for signals 63 and 64.

The loss along a route in TPS 60, as shown for example for route 63, is given by the loss in the switch S1, the loss in the splitter 62-1, then combiner 61-2, and the switch S2. This can be written as 2·(L_{a/d}+Lₛₚₗᵢₜ), where L_{a/d} is the loss of switch block 52 and Lₛₚₗᵢₜ is the loss of the m-way splitter/combiner.

FIG. 8B shows a unidirectional TPS 65 that uses on the input side WSEs 66 and on the output side WSEs 67. The WSEs 66 and 67 are similar in structure with WSE 52 shown in FIG. 8A, with the difference that devices 51 and 52 operate here as splitters, and devices 61 and 62 operate as combiners. The advantage of the unidirectional version of FIG. 8B is that it allows gain flattening. On the other hand, the configuration shown in FIG. 8A uses less WSSs (or smaller port count WSSs) when compared with the unidirectional version of the switch shown in FIG. 8B.

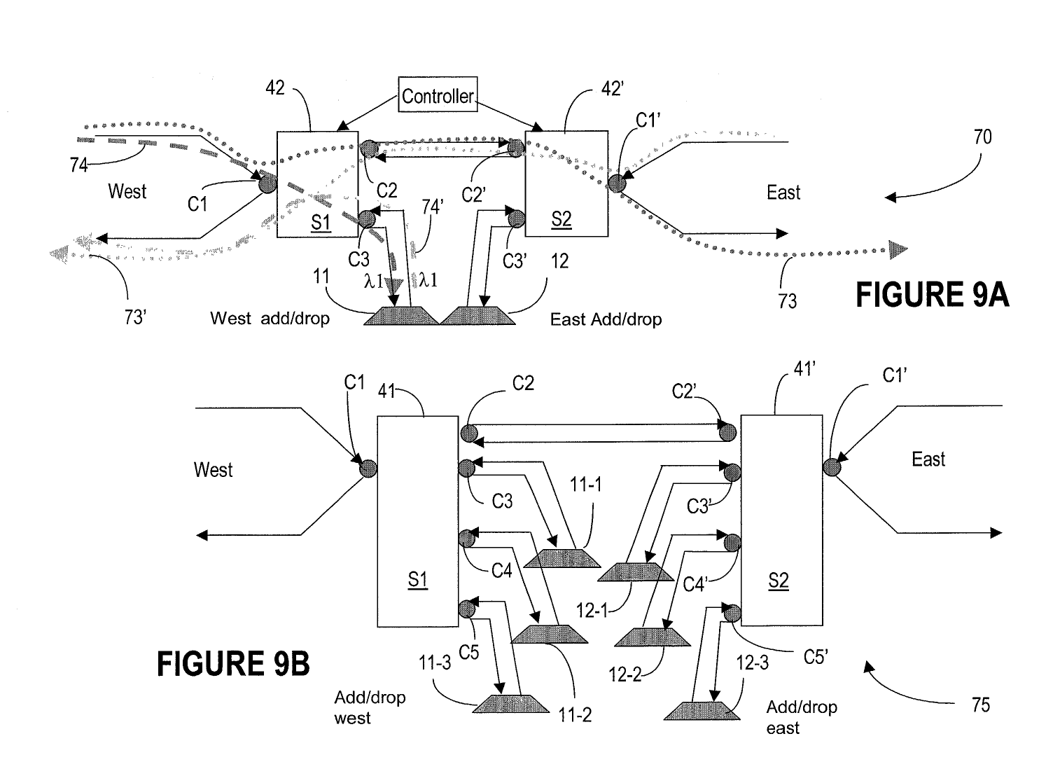

FIGS. 9A and 9B show OADM (optical add/drop multiplexer) configurations, which are a particular case of a TPS. The OADMs may be used at nodes connected on a bidirectional line, or on two unidirectional lines FIG. 9A shows an OADM 70 that uses 1×2 WSSs 42, 42′, denoted with S1 and respectively S2. In this embodiment, one of the add/drop port of switch S1 is coupled to one of the add/drop ports of switch S2 for switching the passthrough channels between the respective eastbound/westbound input lines and output line. The passthrough traffic in the eastbound direction is illustrated in dotted lines at 73 and the passthrough traffic in the westbound direction is shown at 73′. The other add/drop port of switches S1 and S2 is used for add/drop of the local traffic, as shown in dashed lines. Only the drop traffic 74 and add traffic 74′ for the west access system 11 is illustrated for simplification. It is to be noted that west and east are relative terms, used for better describing operation of device 70. To take advantage of the bidirectional nature of the WSSs, switches S1 and S2 are provided with circulators C1, C2, C3 and C1′, C2′, C3′, respectively. This allows the number of switches to be halved compared to a unidirectional configuration (without circulators) while ensuring that no single point of failure affects both eastbound and westbound traffic.

Bidirectional operation of device 70 constrains the bidirectional connections to use the same wavelength in both directions. For example, if a channel λ1 is added to the westbound WDM signal 74′, it must be dropped from eastbound WDM signal 74 also. This constraint is acceptable in long haul networks where the majority of traffic is bidirectional, and where both directions follow reciprocal routes and carry mostly bidirectional traffic. However, in this configuration, per channel conditioning must be applied identically for both directions. This prevents control systems from optimally adjusting power levels according to the specific characteristics of counter-propagating systems, which are typically distinct. In addition, use of two switches on the passthrough traffic results in somewhat important loses and increases the requirements for the WSS filter (filter shape narrowing).

FIG. 9B shows a variant 75 of the embodiment of FIG. 9A that uses WSSs 41 with a larger number of ports, to allow an increased number of add/drop ports. Thus, S1 adds/drops the client traffic from/to west access structure 11, as shown by multiplexers/demultiplexers 11-1, 11-2 and 11-3, while switch S2 adds/drops the client traffic from/to the east access structure 12, as shown by east multiplexers/demultiplexers 12-1, 12-2 and 12-3.

This configuration has the advantage that the add/drop traffic can be distributed to each multiplexer/demultiplexer evenly, to reduce the multiplexers/demultiplexers dilation and cost. It also allows the cost for multiplexers/demultiplexers to be incurred gradually, as the add/drop traffic grows.

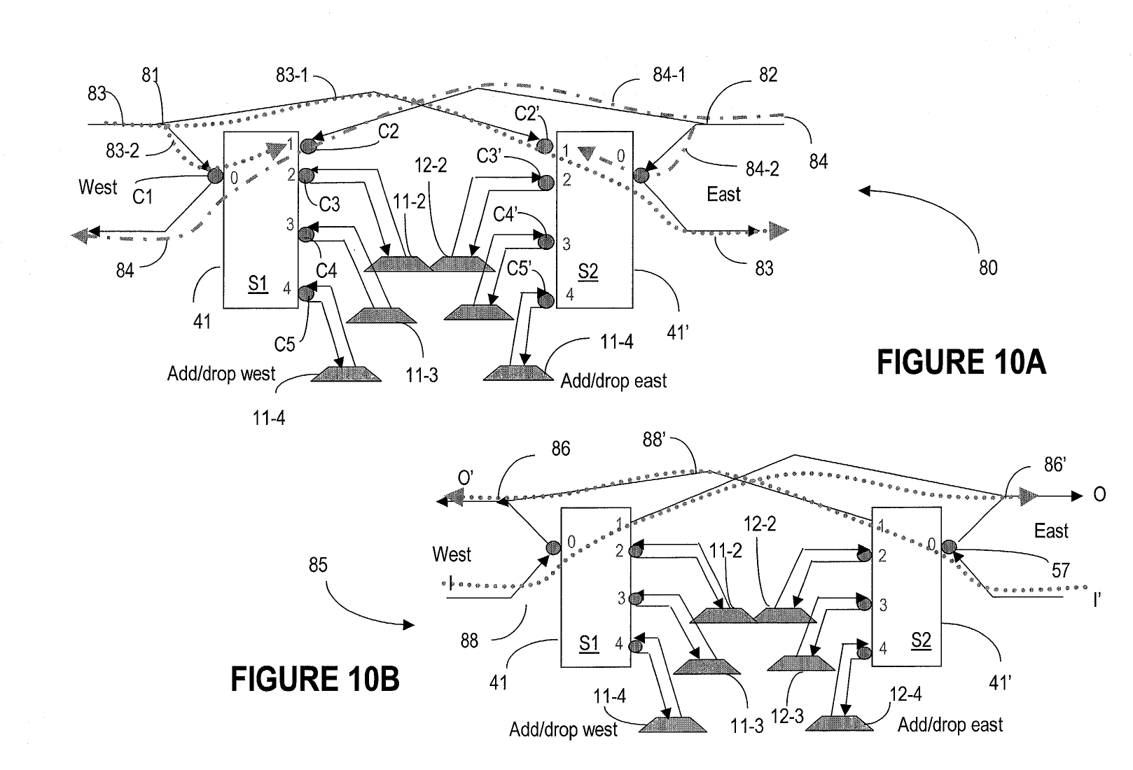

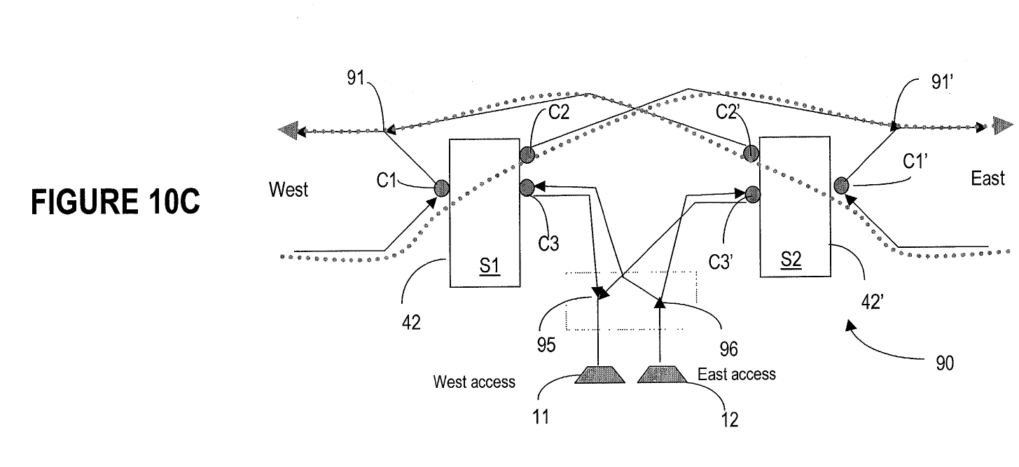

FIG. 10A illustrates an OADM configuration 80 that uses WSSs 41 and 41′ connected to the respective input line over splitters 81, 82. An eastbound input signal 83 is split before entering the input/output port of a first WSS S1, so that a first component 83-1 bypasses switch S1. The second component 83-2 entering S1 is dumped at the C2 circulator/isolator. Drop traffic is directed to the appropriate drop port by the respective S1, S2, while the add traffic is multiplexed with the passthrough traffic in the respective S1, S2. Switch S2 directs the eastbound passthrough traffic onto the eastbound output line, and the east drop traffic to the respective demultiplexer of access structure 12 as needed.

Similarly, the westbound signal 84 is split at 82 and the component 84-1 bypasses S2. S1 directs the westbound passthrough traffic onto the westbound output line, and the west drop traffic to the west demultiplexers of access structure 11 as needed.

The advantage of this configuration is that the passthrough traffic passes through only one WSS, resulting in smaller losses and less filter shape narrowing than when device 70 is used. Furthermore, since eastbound traffic and westbound traffic traverse the WSS unidirectionally, power control can be used effectively, to combat gain non-flatness of the line system. In addition, if port “1” is equipped with a circulator C2, the passthrough signal may be monitored in service, as shown by the respective component 83-2 and 84-2.

FIG. 10B shows another embodiment of an OADM 85 where the through port “1” is unidirectional. In this case, the WSS S1 directs the passthrough traffic in the eastbound input WDM signal 88 from port “0” to port “1”. From port “1”, the passthrough traffic bypasses WSS S2 and is combined with the output eastbound add traffic at combiner 86′. The add traffic is routed by WSS S2 from the respective add port (from multiplexers 12) to the output port “0”. The drop traffic is routed by switch S1 to one of the demultiplexers 11. In this way, the eastbound passthrough traffic passes only through WSS S1. This configuration also allows power grooming on that path.

FIG. 10C shows a further variant 90 of an OADM, where optical splitter/combiners 95, 96 respectively, allow local traffic to be added westbound or eastbound through operation of WSSs S1 and S2. This configuration is useful for wavelength provisioning without costly subtending PXCs (photonic cross-connect) or EXCs (electrical cross-connect). It enables restoration by switching from west to east around the line failure. This configuration can be also used for TPS 80.

We claim

1. A method of routing a communication channel at a transparent photonic switch TPS, comprising:
broadcasting an input multi-channel optical signal along a plurality of internal routes, an internal route for connecting an input port of said TPS to an output port of said TPS;
on each said internal route, selecting a set of channels destined to a respective output port, while blocking all remaining channels destined to other output ports; and
dynamically allocating the channels in said set of channels according to current network-wide connectivity data.

2. In an optical communication network, a transparent photonic switch TPS with n input ports and n output ports, comprising:
an internal route for each I(i)-O(j) pair of ports, where i j,
a wavelength selective element WSE on each internal route for allowing a set of channels to pass from said input port I(i) to said output port O(j), and blocking all channels destined to other output ports O(k), where k j and
a controller for dynamically allocating the channels in said set of channels according to current network-wide connectivity data.

3. A TPS as claimed in claim 2, wherein an input port comprises means for broadcasting an input WDM signal along (n−1) internal routes.

4. A TPS as claimed in claim 3, wherein an output port comprises means for combining an output WDM signal from (n−1) internal routes.

5. A TPS as claimed in claim 2, wherein said WSE comprises a filter with a wavelength dependent transfer characteristic.

6. A TPS as claimed in claim 5, wherein said WSE further comprises an optical amplifier.

7. A TPS as claimed in claim 4, with n(n−1) two-port WSEs and n(n−1) internal routes, to provide a unidirectional TPS.

8. A TPS as claimed in claim 4, with n(n−1)/2 two port WSEs, wherein each said WSE is provided with a circulator on each said port, for connection along two internal routes.

9. In an optical communication network, a transparent photonic switch TPS with n input ports and n output ports, comprising:
for each pair of ports I(i)-O(j), means for routing an eastbound WDM signal and a westbound WDM signal between said input port I(i), output port O(i) and a TPS port P(i);
an internal route for each P(i)-P(j) pair of ports;
a wavelength selective element WSE on each internal route for allowing a set of channels to pass from said port P(i) to said port P(j), and blocking all channels destined to other ports P(p), where p j, and
a controller for dynamically allocating the channels in said set of channels.

10. A transparent photonic switch TPS for an optical communication network comprising:
n bidirectional TPS ports P(i) for connecting said TPS with a respective associated input port I(i) and output port O(i);
on each said port P(i), a wavelength selective element WSE with an express port connected to said port P(i), and (n−1) add/drop ports, for routing a set of channels between said express port and a respective add/drop port;
a plurality of internal routes for connecting each said add/drop port of each WSE(i) with an add/drop port of each other WSE(j), where i j, and
a controller for dynamically allocating the channels in each said set of channels according to current network-wide connectivity data.

11. A TPS as claimed in claim 10, wherein said bidirectional port P(i) comprises a circulator for connecting said associated input port, said associated output port and said express port, to separate/combine a westbound WDM signal from/with an eastbound WDM signal.

12. A TPS as claimed in claim 10, wherein said WSE comprises a 1×(n−1) wavelength selective switch WSS with an input/output port connected to said respective express port and (n−1) WSS add/drop ports, each connected to a respective internal route.

13. A TPS as claimed in claim 10, wherein said WSE comprises two (n−1)/2×1 WSSs, each WSS being connected with an input/output port to said respective express port over a 1:2 splitter/combiner, and with each said (n−1) WSS add/drop ports to a respective internal route,
wherein each said WSS switches a channel from said input/output port to one of said WSS add/drop ports or none, and n is an odd integer.

14. A TPS as claimed in claim 10, wherein said WSE comprises two m×1 WSSs, the input/output port of a first WSS being connected to an add/drop port of said second WSS, and the input/output port of said second WSS being connected to said respective express port of said TPS and with each said remaining WSS add/drop ports to a respective internal route.

15. A TPS as claimed in claim 10, wherein said WSE comprises:
a first 1:2 splitter/combiner with a common port and a first and a second arm, for separating/combining a WDM signal on said common port from/into said arms;
a (n−1)/2×1 WSS with an input/output port connected with said respective express port over said first arm, and with (n−1)/2 WSS add/drop ports;
a second 1:(n−1)/2 splitter combiner with a common port and k/2 arms, connected with said respective express port over said common port,
wherein each said WSS switches a channel from said input/output port to one of said WSS add/drop ports or none, and n is an odd integer.

16. A TPS as claimed in claim 10, wherein said WSE comprises:
a (n−1)/2×1 WSS with an input/output port connected with the respective express port and k/2 add/drop ports;
(n−1)/2 splitters/combiners, each having a common port and (n−1)/2 arms, connected with said common port to an add/drop port, and with said arms to a respective internal route, where n is an odd integer.

17. A transparent photonic switch TPS for an optical communication network comprising:
n input ports I(i) and n output ports O(i);
on each input port I(i), an input wavelength selective element WSE with an express port connected to said input port I(i), and with (n−1) drop ports, for routing said set of channels between said express port and a respective drop port;
on each output port O(i), an output device with an express port connected to said output port O(i), and with (n−1) add ports, for routing said set of channels between a respective add port and said express port;
a plurality of internal routes for connecting each said drop port of each said input WSE(i) with an add port of each other output WSE(j), where i j; and
a controller for dynamically allocating the channels in each said set of channels C(k) according to current network-wide connectivity data.

18. A TPS as claimed in claim 17, wherein said input WSE comprises:
a 1×(n−1)/2 WSS with an input port connected with a respective input port and (n−1)/2 drop ports;
a 1:(n−1)/2 splitter with a common port connected to a respective drop port of said WSS and (n−1)/2 arms, each connected to a respective internal route.

19. A TPS as claimed in claim 17, wherein said output device comprises
a 1×(n−1)/2 WSS with an output port connected with the respective output port and (n−1)/2 add ports;
a (n−1)/2:1 combiner with a common port connected to a respective add port and (n−1)/2 arms, each connected to a respective internal route.

20. A TPS as claimed in claim 17, wherein said input WSE comprises:
a 1:2 splitter with a common port a first and a second arm, having said common port connected to a respective TPS input port,
a 1:(n−1) splitter with a common port and (n−1)/2 drop arms, having said common port connected to said first arm of said 1:2 splitter; and
a 1×(n−1)/2 WSS with a bidirectional input/output port and (n−1)/2 WSS add/drop ports, said bidirectional input/output port being connected to said second arm of said 1:2 splitter.

21. A TPS as claimed in claim 17, wherein said output device comprises:
a 2:1 combiner with a common port, a first and a second arm, having said common port connected to the respective TPS output port;
a (n−1):1 combiner with an output port and (n−1)/2 add arms, having said output port connected with said first arm of said 2:1 combiner;
a (n−1)/2×1 WSS(i) with a bidirectional input/output port and (n−1)/2 WSS add/drop ports, said bidirectional input/output port being connected to said second arm of said 2:1 combiner.

22. In an optical communication network, an optical add/drop multiplexer OADM with a first and a second line port connected into a bidirectional line, comprising:
a first 1×n wavelength selective switch WSS with a first input/output port, a first through port and a plurality (n−1) of first add/drop ports, for routing a set of passthrough channels between said first line port and said first through port;
a second 1×m WSS with a second input/output port, a second through port and a plurality (m−1) of second add/drop ports for routing said set of passthrough channels between said second line port and said second through port;
a passthrough route for routing said passthrough channels between said first and second line ports; and
a controller for dynamically allocating the channels in said set of passthrough channels according to current network-wide connectivity data.

23. An OADM as claimed in claim 22, further comprising (n−1) bidirectional west routes for connecting each said first add/drop port to a west access structure to route a plurality of west local channels between said first express port and said west access structure, wherein n 2

24. An OADM as claimed in claim 22, further comprising (m−1) bidirectional east routes for connecting each second add/drop port to an east access structure, for routing a plurality of east local channels between said second input/output port and said east access structure, wherein m 2

25. An OADM as claimed in claim 22, wherein said first and second input/output ports, said first and second through ports, said (n−1) first add/drop ports, and said (m−1) second add/drop ports are provided with means for making each said respective port bidirectional.

26. An OADM as claimed in claim 22, wherein said first input/output port is connected directly to said first line port, said second input/output port is connected directly to said second line port, and said first through port is connected with said second through port.

27. An OADM as claimed in claim 22, further comprising:
a first splitter/combiner with a common port, a first arm and a second arm, wherein said common port is connected to said first line port, said first arm is connected to said second through port and said second arm is connected to said first input/output port; and
a second splitter/combiner with a common port, a first arm and a second arm, wherein said common port is connected to said second line port, said first arm is connected to said first through port and said second arm is connected to said second input/output port.

28. An OADM as claimed in claim 27, wherein said first and second through ports are unidirectional.

29. An OADM as claimed in claim 22, further comprising:
means for routing a plurality of drop channels from said first and second add/drop ports to a west and east access structure, and routing a plurality of add channels to said first and second add ports from both said west and east access structure
(n−1) bidirectional west routes for connecting each first add/drop port to said means for routing; and
(m−1) bidirectional east routes for connecting each second add/drop port to said means for routing.
